(19) United States
(12) Patent Application Publication
(10) Pub. No.: US 2015/0073848 A1
(43) Pub. Date: Mar. 12, 2015

(54) DEAL STAGE DATA VISUALIZATION AND USER INTERFACE

(71) Applicant: Oracle International Corporation, Redwood Shores, CA (US)

(72) Inventors: Mark Field, Redwood Shores, CA (US); Dave Stephens, Half Moon Bay, CA (US); Jeffrey Pease, San Francisco, CA (US); Heather Weir, Sunnyvale, CA (US); Daniel Valdivia Milanes, Belmont, CA (US); Miguel Aramis Ramirez Ibarra, La Calma (MX); Bao Liu, Santa Clara, CA (US)

(73) Assignee: Oracle International Corporation, Redwood Shores, CA (US)

(21) Appl. No.: 14/025,743

(22) Filed: Sep. 12, 2013

(51) Int. Cl. G06Q 10/06

(52) U.S. Cl. CPC G06Q 10/063114
USPC 705/7.15

(57) ABSTRACT

Data visualizations and user interfaces help managers view the totality of deal opportunities in progress and identify potential shortfalls. A deal stage visualization includes deal stage regions corresponding with deal stages and arranged along a first axis. Deal icons represent individual pending deals and are assigned to one of the deal stages. The set of deal icons associated with each deal stage form a deal icon set. The deal stage visualization also includes a second axis representing aggregate values of the deal stages. Each deal icon set is associated with a display region having a displayed size along the second axis that is proportional to an aggregate value of its included deal icons. Different icon sets with different aggregate deal values will have different size scrollable display areas. The size of the display area associated with an icon set remains unchanged during scrolling.

### CROSS REFERENCES TO RELATED APPLICATIONS

This application is related to the following applications, Attorney Docket Number-ORACP0103, U.S. patent application Ser. No. , entitled DATA VISUALIZATION AND USER INTERFACE FOR MONITORING AND PREDICTION OF DEAL PERFORMANCE, filed on Sep. 12, 2013, and Attorney Docket Number-ORACP0105, U.S. patent application Ser. No. , entitled DATA VISUALIZATION AND USER INTERFACE FOR MONITORING RESOURCE ALLOCATION TO CUSTOMERS, filed on Sep. 12, 2013, which are hereby incorporated by reference, as if set forth in full in this specification:

### BACKGROUND

This application relates to the field of user interfaces for visualizing and forecasting deal and other enterprise data. Customer Relation Management (CRM) applications are intended to organize and automate interactions between an organization's representatives, such as salespeople, and the organization's customers and potential customers. CRM applications can assist organizations with managing interactions with customers and potential customers in a number of different ways.

Monitoring the activity of salespeople on deal opportunities is one task typically performed by CRM applications. Deal managers may view the data collected by CRM applications to monitor the activities of their salespeople. One task for managers is to ensure that their sales organizations meet their near-term and long-term targets. To do this, it is important for managers to be able to identify deal opportunities in progress and identify any potential shortfalls or bottlenecks as soon as possible so that corrective action may be taken. It is also important for managers to be able to identify deal opportunities that are not making sufficient progress so that additional resources or other actions may be applied to move these stalled deal opportunities towards closing.

Unfortunately, current CRM applications do not make it easy for deal managers to view the totality of deal opportunities in progress and identify potential shortfalls. Current CRM applications often present deal opportunity data in a tabular format and require deal managers to sort and manually analyze columns of data to understand the overall status of the deal opportunities in progress.

### SUMMARY

An embodiment of the invention includes a set of data visualizations and user interfaces adapted to help deal managers view the totality of deal opportunities in progress and identify potential shortfalls. In an embodiment, a deal stage visualization includes deal stage regions corresponding with deal stages and arranged along a first axis. Deal icons represent individual pending deals. Each pending deal, and its associated deal icon is assigned to one of the deal stages. The deal icons are assigned to the deal icon sets. Each deal icon set is associated with one of the deal stages and is positioned in the corresponding deal stage region. Each deal icon set includes a portion of the deal icons associated with the same deal stage as the deal icon set. The deal stage visualization also includes a second axis representing aggregate values of the deal stages. Each deal icon set is associated with a display region having a displayed size along the second axis that is proportional to an aggregate value of its included deal icons.

Depending on the number of deals in each deal stage and their aggregate value, a portion of the deal icons in an icon set may not be visible in the icon set's display area. In this situation, an embodiment of the invention allows a user to scroll the icon set to view other deal icons. In still another embodiment, two different icon sets with different aggregate deal values will have different size scrollable display areas. In a further embodiment of the invention, the size of the display area associated with an icon set remains unchanged during scrolling.

A further understanding of the nature and the advantages of particular embodiments disclosed herein may be realized by reference of the remaining portions of the specification and the attached drawings.

### BRIEF DESCRIPTION OF THE DRAWINGS

The invention will be described with reference to the drawings, in which:

FIG. 1 illustrates an example data visualization and user interface according to an embodiment of the invention;

FIG. 2 illustrates example scrolling visualizations according to an embodiment of the invention;

FIG. 3 illustrates an example first detail view of the data visualization and user interface according to an embodiment of the invention;

FIG. 4 illustrates an example second detail view of the data visualization and user interface according to an embodiment of the invention;

FIG. 5 illustrates an example method of setting scrolling regions for a data visualization and user interface according to an embodiment of the invention; and

FIG. 6 illustrates an example system suitable for implementing embodiments of the invention.

### DETAILED DESCRIPTION OF EMBODIMENTS

An embodiment of the invention includes a set of data visualizations and user interfaces adapted to help deal managers view the totality of deal opportunities in progress and identify potential shortfalls.

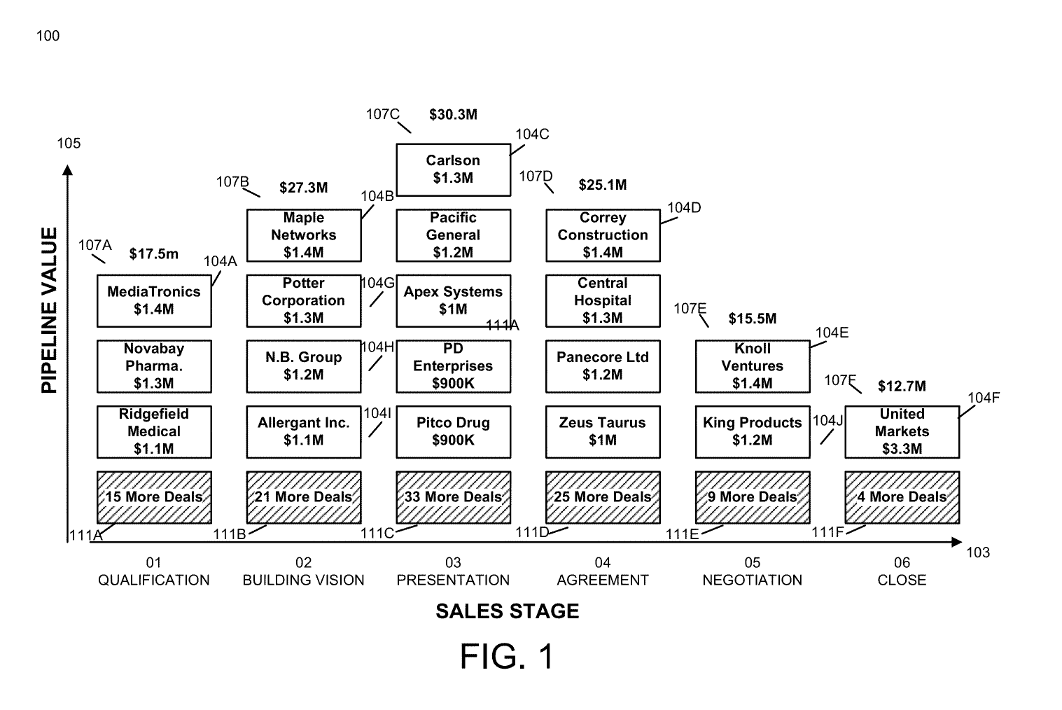

FIG. 1 illustrates an example data visualization and user interface 100 according to an embodiment of the invention. Example data visualization 100 includes a horizontal axis 103 representing varies stages or statuses of pending deal opportunities. The deal opportunity stages in this example include: Qualification; Building Vision; Presentation; Agreement; Negotiation; and Close. However, embodiments of the invention may be utilized with any type classification system for deal opportunities and include any arbitrary number of deal opportunity stages. In some implementations, horizontal scrolling may be enabled to display additional deal stages along the horizontal axis.

Example data visualization displays deal icons 104, each representing an individual deal opportunities, according to their associated deal opportunity stages. For example, deal icons 104A, 104B, 104C, 104D, 104E, and 104F are displayed in deal opportunity stages Qualification; Building Vision; Presentation; Agreement; Negotiation; and Close, respectively.

In general, each deal opportunity is initialized and assigned to one of the deal stages. As deal opportunities progress, they are reassigned to the appropriate stage and displayed by example data visualization 100. In example 100, deal opportunity stages are arranged in sequence from left to right. Typical deals opportunities will start in the Qualification stage and gradually move through the other stages in sequence until, if they are successful, they reach the Close stage. This visualization of the set of deal opportunity stages in sequence is referred to as a deal pipeline.

Example data visualization 100 also includes a vertical axis 105 representing the aggregate monetary value of the deal opportunities in each of the deal opportunity stages. In an embodiment, example data visualization 100 displays all or a portion of deal icons assigned to each deal opportunity stage in this form of an icon set 107. Each of the displayed sets 107 of deal icons has a height that is fixed based on the total monetary value of that deal stage's pending deal opportunities. For example, the Qualification stage is displayed with set 107A of deal icons scaled to a vertical height representing $17.5 M in total deal values. The Building Vision stage is displayed with set 107B of deal icons scaled to a vertical height representing $27.3 M in total deal values. Because the Building Vision stage has pending deal opportunities with a higher value than the Qualification stage, set 107B is proportionally higher than set 107A. Sets 107C, 107D, 107E, and 107F are similarly displayed with heights proportional to total value of deal opportunities in the Presentation, Agreement, Negotiation, and Close stages, respectively.

Each of the sets 107 of deal icons displays all or a portion of the deal icons assigned to that deal stage. In an embodiment, deal icons 104 are displayed in each set 107 in order of decreasing monetary value.

Depending on the total number deals in a deal stage and the value of the deal opportunities in that stage relative to the other deal stages, some of the deal opportunities assigned to a deal stage may not be visible in a set 107 of deal icons. In situations where there is not sufficient vertical space to display icons for all of the deals assigned to a deal stage in a set 107, an indicator 111 is included in the icon set indicating that there are additional deal opportunities assigned to that deal stage. For example, indicators 111A, 111B, 111C, 111D, 111E, and 111F indicate that there are additional deal opportunities assigned to the Qualification, Building Vision, Presentation, Agreement, Negotiation, and Close deal stages. In a further embodiment, each of the indicators 111 specifies the number of additional deal opportunities assigned to their respective deal stages.

In yet a further embodiment, a user may apply one or more filters to expand or restrict the number and/or type of deal opportunities presented in this data visualization and user interface. Example filters include deal sizes, time frames, specific deal region, product category, management or deal group, industry or market segment, or any other category associated with the deal opportunity, the organization, or the potential customer. Filters may be enabled, disabled, and configured through the use of menu items, user interface buttons, and/or any other types of user interface input widgets or elements known in the art.

In an additional embodiment, the sets of deal icons displayed for each deal stage may be scrolled to reveal deal icons that were previously not visible. As described in detail below, scrolling sets of deal icons does not change the vertical height of each icon set, thereby preserving a visual indication of the relative value of the deal opportunities in each deal stage.

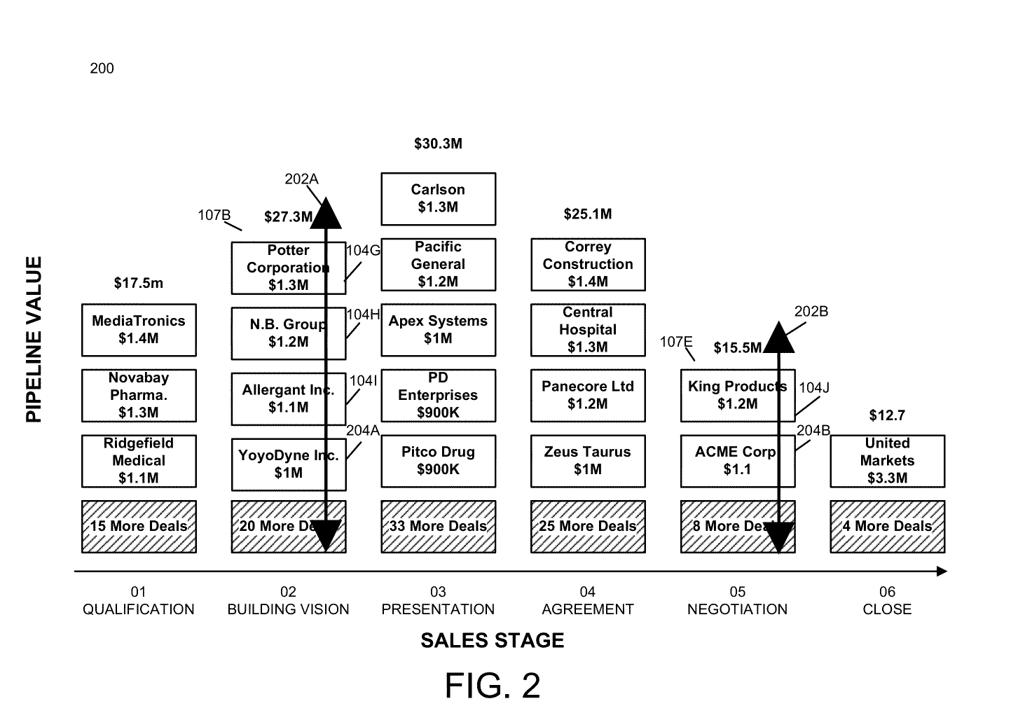

FIG. 2 illustrates example scrolling visualizations 200 according to an embodiment of the invention. In this example 200, a user may vertically scroll the icon set associated with each deal stage to view deal icons for any of the deal opportunities assigned to that deal stage. For example, a user may provide a scroll input 202A to icon set 107B, as shown in FIG. 2. In response to this scroll input, one or more of the deal icons previously displayed will be scrolled upwards or downwards. Additionally, one or more of the previously displayed deal icons may be removed from the example visualization to preserve the relative height of the icon set.

For example, in response to scroll input 202A, deal icons 104G, 104H, and 1041, shown in FIG. 1, are scrolled upwards in the icon set 107B, as shown in FIG. 2. This upward scrolling provides room to display one or more additional deal icons for deals assigned to this deal stage. For example, deal icon 204A is now displayed in icon set 107B in example 200.

In an embodiment, scrolling sets of deal icons does not change the vertical height of each icon set. This preserves a visual indication of the relative value of the deal opportunities in each deal stage. To avoid changing the height of an icon set when icons are vertically scrolled within the set, an embodiment of the invention removes icons at the top of the icon set from view as they approach and/or cross the top boundary of the icon set. For example, deal icon 104B is shown at the top of the icon set 107B in example 100. During vertical scrolling, as shown in example 200, this icon 104B is removed from view, so that the overall height of the icon set 107B remains approximately the same as that shown in example 100.

In this embodiment, it should be noted that each icon set includes its own vertical boundary for scrolling that may be different than the boundary of other icon sets. For example, icon set 107E has a lower height than icon set 107B, reflecting the lower total monetary value of the deal opportunities assigned to this deal stage. As a result, when a user applies scroll input 202B to icon set 107E in example 200, deal icon 104E, shown in FIG. 1, is removed from view, and, as shown in FIG. 2, deal icon 104J is scrolled upwards and deal icon 204B is displayed in icon set 107E. In this example 200, the overall height of the icon set 107E remains approximately the same as that shown in example 100, regardless of which specific deal icons associated with this deal stage are displayed in the icon set 107E.

Scroll inputs may be applied by users using any type of input device and/or input technique known in the art, including mice, trackballs, keyboards, touchpads, touch screens, voice commands, and/or gesture interface device.

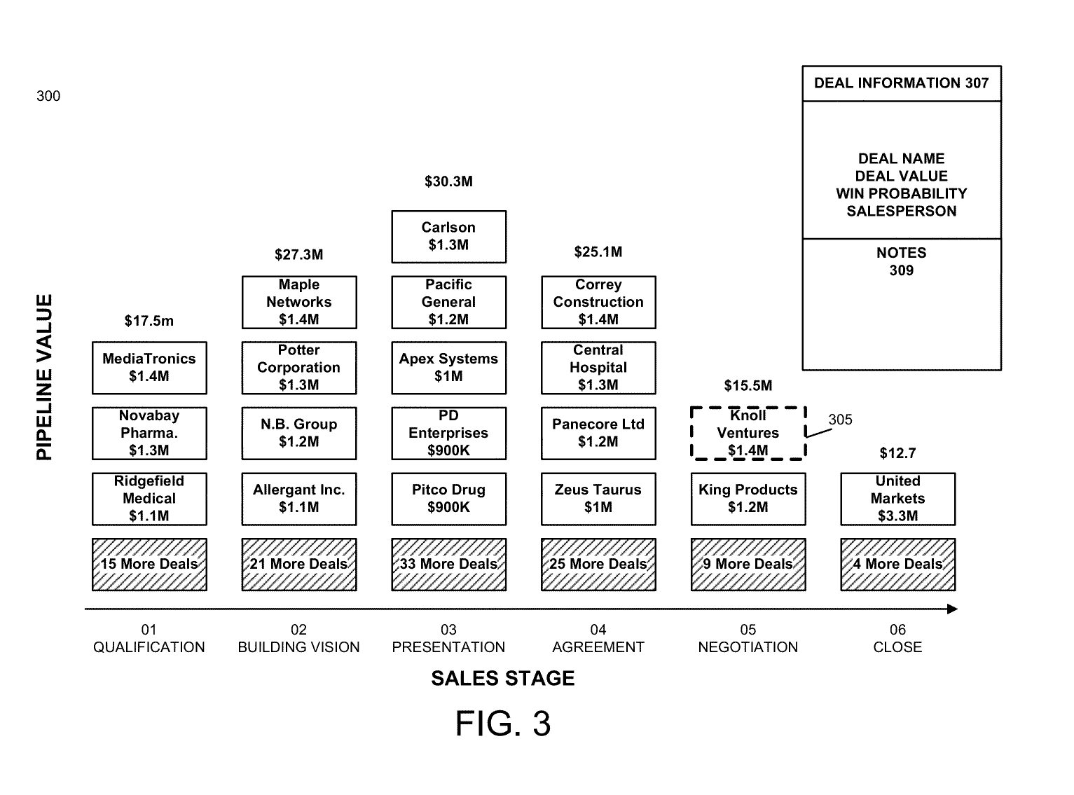

In addition to viewing information about deal opportunities as described in examples 100 and 200, a further embodiment of the invention provides detailed information on specific deal opportunities. FIG. 3 illustrates an example first detail view 300 of the data visualization and user interface according to an embodiment of the invention.

Example 300 includes a display of a deal pipeline and deal icon sets for each deal stage, similar to examples 100 and 200 discussed above. Upon receiving a user selection of one or more of the deal icons, example 300 presents additional information about this specific deal opportunity in a panel or window. For example, if a user selects deal icon 305, panel 307 will be displayed with additional information about this associated deal opportunity.

Examples of additional deal information include, but are not limited to: the deal name, the deal value, the deal win probability, the responsible salesperson or team, the length that the deal has been pending, the sales stage that the deal is in, the amount of time that the deal has been in its current sales stage, the deal forecast, the estimated deal close date, potential deal competitors, and the status of the deal.

In a further embodiment, the panel 307 may include an area 309 for the user to enter notes about the deal. In yet a further embodiment, these notes may be recorded in a CRM or other application and/or distributed to other individuals or groups associated with the selected deal.

In an embodiment, a user may tap an icon to dismiss panel 307 or a different deal icon to view its deal information.

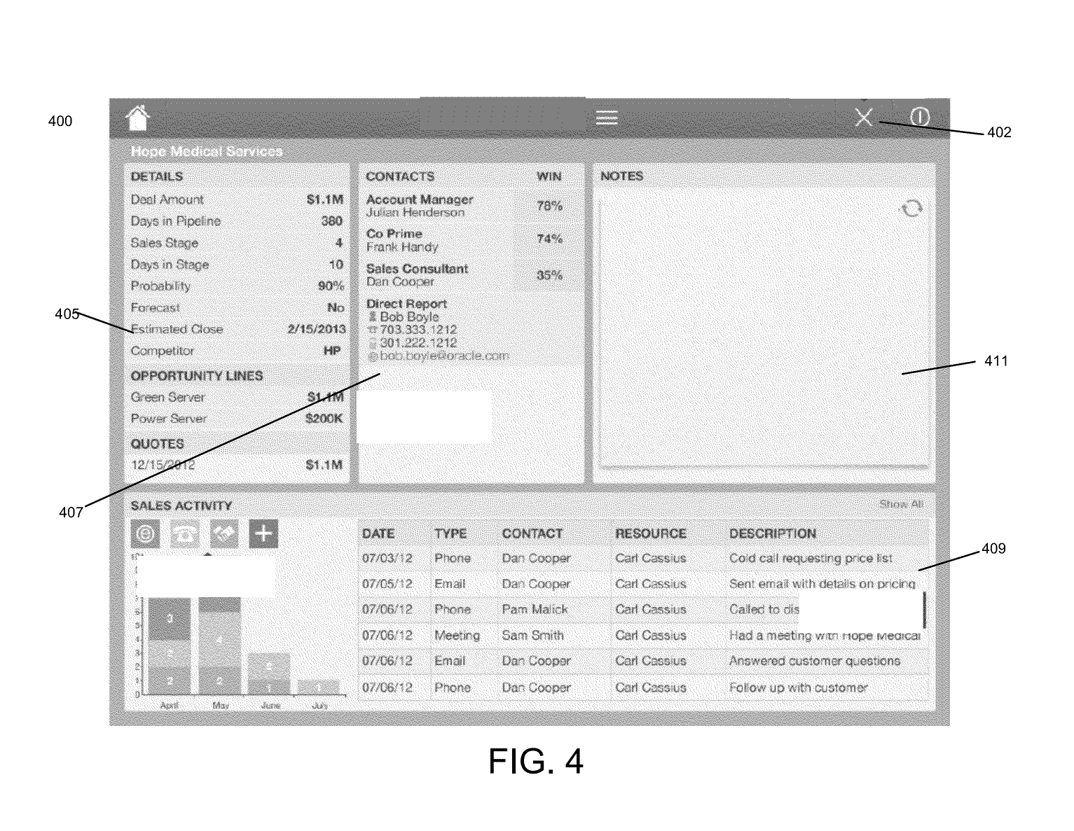

FIG. 4 illustrates an example second detail view 400 of the data visualization and user interface according to an embodiment of the invention. In an embodiment, the second detail view 400 may be displayed with a user selects an icon in a panel 307 for a selected deal opportunity in detail view 300. Selecting an icon 402 in the second detail view 400 closes this view and returns to detail view 300 or the data presentation example 100.

In the second detail view 400, a user may view addition specific information about the pending deal opportunity, including a summary of the deal information 405, deal contact information 407, recent activity associated with the deal 409, and notes 411 about the deal. Notes 411 may be edited, added, saved to a CRM or other application, and/or distributed to other users via this view. Deal information may be displayed in detail view 400 in tabular and/or graphical format. Scrolling, filtering, searching, and/or sorting functions may also be included to assist users in retrieving information about the deal opportunity.

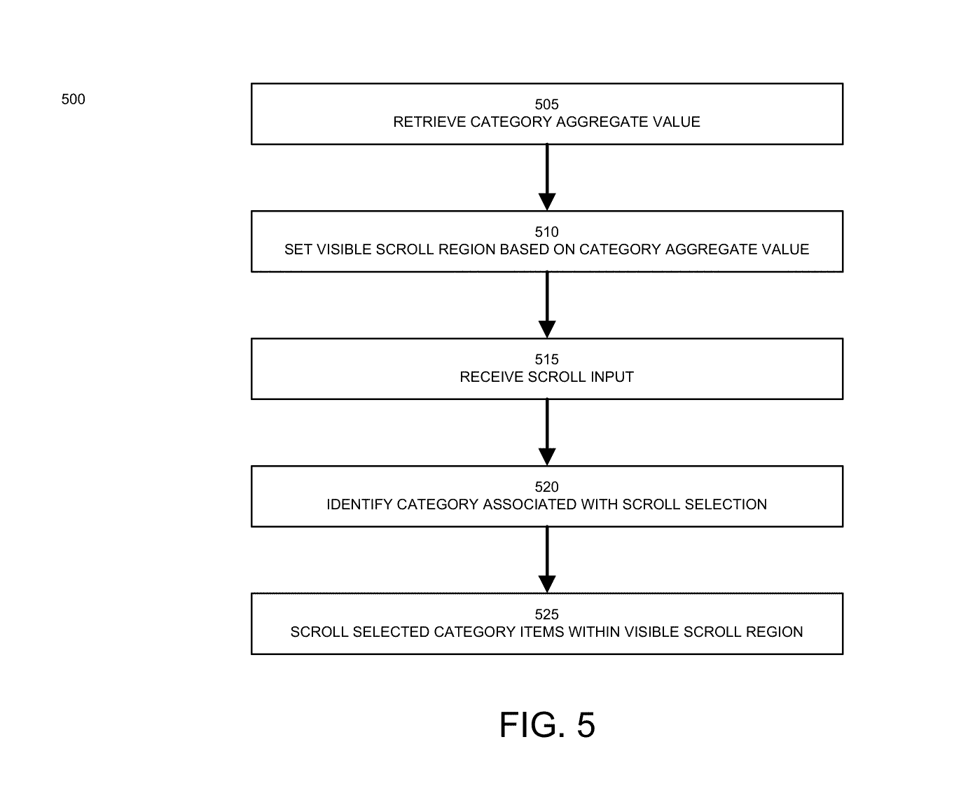

As discussed above, the sets of deal icons displayed for each deal stage may be scrolled to reveal deal icons that were previously not visible. However, scrolling sets of deal icons does not change the vertical height of each icon set. This preserves a visual indication of the relative value of the deal opportunities in each deal stage. FIG. 5 illustrates an example method 500 of setting scrolling regions for a data visualization and user interface according to an embodiment of the invention.

In method 500, step 505 retrieves the aggregate value of a category, such as a deal stage. Step 510 then sets the visible scroll region for this category based on the category's aggregate value. In an embodiment, step 510 compares the selected category's aggregate value to the values associated with the other categories to determine a relative display size for the selected category. This embodiment of step 510 then sets the visible scroll region and/or scroll boundaries of this category using an API or other program interface to a graphical user interface library, toolkit, web browser, and/or operating system.

Steps 505 and 510 optionally may be repeated as many times as necessary so that two or more visible categories have visible scroll regions set.

Step 515 receives a scroll input from a user. Scroll inputs received from users using any type of input device and/or input technique known in the art, including mice, trackballs, keyboards, touchpads, touch screens, voice commands, and/or gesture interface device.

Step 520 identifies a category associated with a scroll input, and step 525 scrolls the items in that category, such as deal icons, within the visible scroll region based on the scroll input. In an embodiment, the appearance and disappearance of items at the boundaries of the visible scroll region during scrolling is handled automatically by the graphical user interface library, toolkit, web browser, and/or operating system, based on the boundaries of the visible scroll region as specified by step 510. In alternate embodiment, an application program is responsible for the appearance and disappearance of items at the boundaries of the visible scroll region during scrolling.

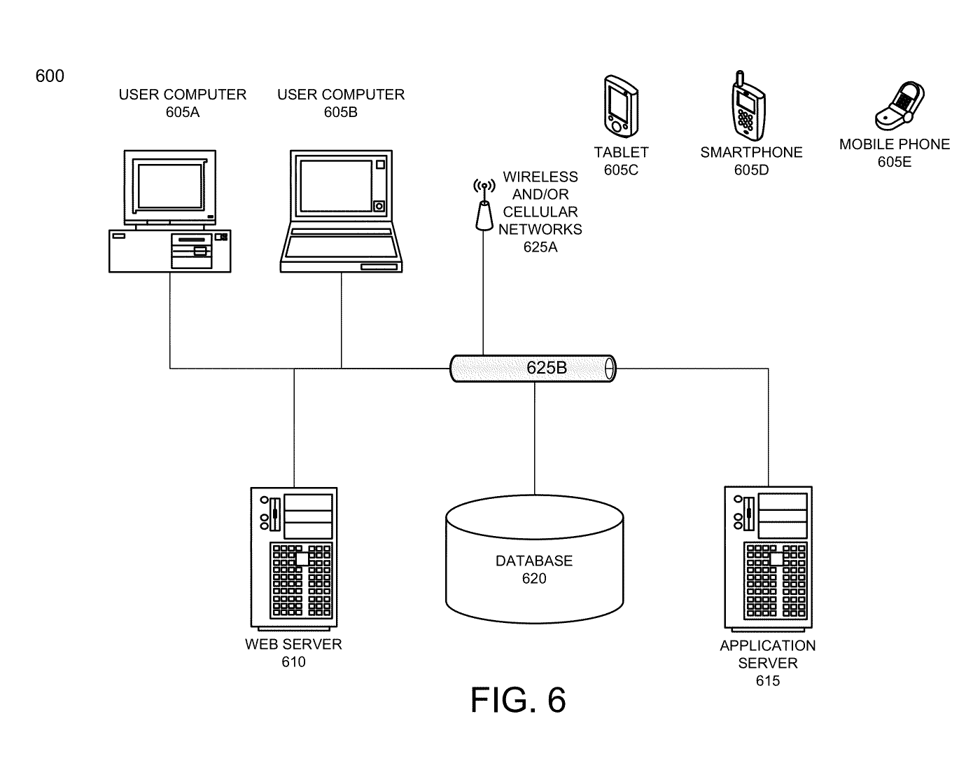

FIG. 6 illustrates an example system 600 suitable for implementing embodiments of the invention. Embodiments of the invention may be implemented as standalone applications or as web-based applications implemented using a combination of client-side and server-side code. The system includes user computers 605 including desktop 605A and portable personal computers 605B, tablets 605C, smartphones 605D, and mobile phones 605E. The system can interface with any type of electronic device, such as a thin-client computer, Internet-enabled mobile telephone, mobile Internet access device, tablet, electronic book, or personal digital assistant, capable of displaying and navigating web pages or other types of electronic documents and/or executing applications. Although the system 600 is shown with five user computers, any number of user computers can be supported.

A web server 610 is used to process requests from web browsers and standalone applications for web pages, electronic documents, enterprise data or other content, and other data from the user computers. The server 610 may also provide the menu application, as well as syndicated content, such as RSS feeds, of data related to enterprise operations.

Application server 615 operates one or more mobile applications. The mobile applications can be implemented as one or more scripts or programs written in any programming language, such as Java, C, C++, C#, or any scripting language, such as JavaScript or ECMAScript, Perl, PHP, Python, Ruby, or TCL. Data applications can be built using libraries or application frameworks, such as Rails, Enterprise JavaBeans, or .NET.

The data applications on application server 615 process input data and user computer requests and can store or retrieve data from database 620. Database 620 stores data created and used by the data applications. In an embodiment, the database 620 is a relational database that is adapted to store, update, and retrieve data in response to SQL format commands or other database query languages. In other embodiments, unstructured data storage architectures and NoSQL databases may also be used.

In an embodiment, the application server 615 is one or more general-purpose computers capable of executing programs or scripts. In an embodiment, the web server 610 is implemented as an application running on one or more general-purpose computers. The web server and application server may be combined and executed on the same computers.

An electronic communication network 625 enables communication between user computers 605, web server 610, application server 615, and database 620. In an embodiment, network 625 may further include any form of electrical or optical communication devices, including wireless 625A and wired 625B networks. Network 625 may also incorporate one or more local-area networks, such as an Ethernet network; wide-area networks, such as the Internet and cellular carrier data networks; and virtual networks, such as a virtual private network.

The system is one example for executing mobile applications according to an embodiment of the invention. In another embodiment, application server, web server, and optionally database can be combined into a single server computer application and system. In a further embodiment, virtualization and virtual machine applications may be used to implement one or more of the application server, web server, and database. In still further embodiments, all or a portion of the web server and application functions may be integrated into an application running on each of the user computers. For example, a JavaScript application on the user computer may be used to retrieve or analyze data and display portions of the applications.

Although the description has been described with respect to particular embodiments thereof, these particular embodiments are merely illustrative, and not restrictive. Any suitable programming language can be used to implement the routines of particular embodiments. Any type of programming techniques may be employed including procedural, functional, and/or object oriented programming techniques. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method of presenting deal information, the method comprising:
generating a deal stage visualization including:
deal stage regions arranged along a first axis representing deal stages, wherein each deal stage region corresponds to one of a set of deal stages;
deal icons, wherein each deal icon represents an individual pending deal that is assigned to one of the deal stages;
deal icon sets, wherein each deal icon set is associated with one of the deal stages and is positioned in the corresponding deal stage region, wherein each deal icon set includes a portion of the deal icons associated with the same deal stage as the deal icon set; and
a second axis representing aggregate values of the deal stages, wherein each deal icon set is associated with a display region having a displayed size along the second axis that is proportional to an aggregate value of its included deal icons; and
providing the deal stage visualization for display by an electronic device.

2. The method of claim 1, wherein a first one of the icon sets displays a first portion of its included deal icons in its display area and does not display a second portion of its included deal icons in its display area.

3. The method of claim 2, comprising:
receiving at least one user input selecting and scrolling the first one of the icon sets;
in response to the user input, scrolling the first portion of the included deal icons out of the display area, such that the first portion of the included deal icons are no longer displayed, and scrolling the second portion of the included deal icons into the display area, such that the second portion of the included deal icons are displayed in the display area.

4. The method of claim 3, wherein the displayed size of the display area of the first one of the icon sets with respect to the second axis remains substantially unchanged during the scrolling of the first and second portions of the included deal icons.

5. The method of claim 2, wherein the first one of the icon sets includes an indicator in its display area, wherein the indicator indicates the size of the second portion of the included deal icons.

6. The method of claim 1, wherein a first one of the icon sets includes a first display area having a different size with respect to the second axis than a second display area associated with a second one of the icon sets.

7. The method of claim 1, wherein each deal icon displays at least one attribute of the corresponding pending deal.

8. The method of claim 1, comprising:
receiving at least one user input selecting a first one of the deal icons; and
in response to the user input, generating a display of additional deal information from its respective pending deal.

9. The method of claim 1, comprising:
receiving at least one user input specifying at least one filtering parameter; and
in response to the user input:
removing at least a portion of the deal icons from the deal stage visualization that do not satisfy the filtering parameter; and
modifying the displayed size of at least one of the display regions based on the aggregate value of the remaining deal icons included in the associated one of the deal icon sets.

10. The method of claim 9, wherein the filtering parameter is based on a category value, wherein the category value belongs to at least one category including deal region, product category, management group, deal group, industry segment, and/or market segment.

11. A tangible, computer-readable information storage medium including instructions adapted to direct a computer to display a user interface, the user interface comprising:
deal stage regions arranged along a first axis representing deal stages, wherein each deal stage region corresponds to one of a set of deal stages;
deal icons, wherein each deal icon represents an individual pending deal that is assigned to one of the deal stages;
deal icon sets, wherein each deal icon set is associated with one of the deal stages and is positioned in the corresponding deal stage region, wherein each deal icon set includes a portion of the deal icons associated with the same deal stage as the deal icon set; and
a second axis representing aggregate values of the deal stages, wherein each deal icon set is associated with a display region having a displayed size along the second axis that is proportional to an aggregate value of its included deal icons.

12. The tangible, computer-readable information storage medium of claim 11, wherein a first one of the icon sets displays a first portion of its included deal icons in its display area and does not display a second portion of its included deal icons in its display area.

13. The tangible, computer-readable information storage medium of claim 12, comprising:
a deal stage selection and scrolling user interface function for receiving at least one user input selecting and scrolling the first one of the icon sets;
a deal stage scrolling function for scrolling the first portion of the included deal icons out of the display area, such that the first portion of the included deal icons are no longer displayed, and scrolling the second portion of the included deal icons into the display area, such that the second portion of the included deal icons are displayed in the display area, in response to the user input.

14. The tangible, computer-readable information storage medium of claim 13, wherein the displayed size of the display area of the first one of the icon sets with respect to the second axis remains substantially unchanged during the scrolling of the first and second portions of the included deal icons.

15. The tangible, computer-readable information storage medium of claim 12, wherein the first one of the icon sets includes an indicator in its display area, wherein the indicator indicates the size of the second portion of the included deal icons.

16. The tangible, computer-readable information storage medium of claim 11, wherein a first one of the icon sets includes a first display area having a different size with respect to the second axis than a second display area associated with a second one of the icon sets.

17. The tangible, computer-readable information storage medium of claim 12, wherein each deal icon displays at least one attribute of the corresponding pending deal.

18. The tangible, computer-readable information storage medium of claim 11, comprising:
a deal detail user interface input for receiving a user input and generating a display of additional deal information associated with a selected one of the deal icons in response to the user input.

19. The tangible, computer-readable information storage medium of claim 11, comprising:
a deal filtering user interface input for receiving a user input specifying at least one filtering parameter; and in response to the user input, removing at least a portion of the deal icons from the deal stage visualization that do not satisfy the filtering parameter; and modifying the displayed size of at least one of the display regions based on the aggregate value of the remaining deal icons included in the associated one of the deal icon sets.

20. A system comprising:
a client system;
a database storing pending deal data; and
an application server connected with the database and the client system via at least one network, wherein the application server is adapted to retrieve the deal data from the database and communicate the retrieved deal data with the client system;
wherein the client system includes an application including instructions executable by the client system to perform a method, the method comprising:
generating a deal stage visualization including:
deal stage regions arranged along a first axis representing deal stages, wherein each deal stage region corresponds to one of a set of deal stages;
deal icons, wherein each deal icon represents an individual pending deal that is assigned to one of the deal stages;
deal icon sets, wherein each deal icon set is associated with one of the deal stages and is positioned in the corresponding deal stage region, wherein each deal icon set includes a portion of the deal icons associated with the same deal stage as the deal icon set; and
a second axis representing aggregate values of the deal stages, wherein each deal icon set is associated with a display region having a displayed size along the second axis that is proportional to an aggregate value of its included deal icons; and
providing the deal stage visualization for display by an electronic device. Oracle Matter No.
